(19) United States
(12) Patent Application Publication
(10) Pub. No.: US 2013/0091154 A1
(43) Pub. Date: Apr. 11, 2013

(54) Method And Apparatus For Encapsulating Coded Multi-Component Video

(71) Applicants: Zhenyu Lu, Plainsboro, NJ (US); Li Hua Zhu, Burbank, CA (US)

(72) Inventors: Zhenyu Lu, Plainsboro, NJ (US); Li Hua Zhu, Burbank, CA (US)

(73) Assignee: THOMSON LICENSING, Issy de Moulineaux (FR)

(21) Appl. No.: 13/703,936

(22) PCT Filed: Jun. 13, 2011
(86) PCT No.: PCT/US11/40164

§ 371 Date: Dec. 13, 2012

Related U.S. Application Data
(60) Provisional application No. 61/354,433, filed on Jun. 14, 2010.

(51) Int. Cl. G06F 17/30

(52) U.S. Cl. CPC G06F 17/30076
USPC 707/755

(57) ABSTRACT

A method and a device for encapsulating a media entity containing more than one layer into multiple component files, each for one layer, are described along with the corresponding method and device for component file reading. Extensions to the Extractor data structure of SVC/MVC file formats are proposed. The extractor extensions of the invention enable NAL units referencing across different component files. The present invention enables adaptive HTTP streaming of media entities.

### CROSS-REFERENCE TO RELATED APPLICATIONS

The present application for patent claims the benefit of priority from U.S. Provisional Patent Application Ser. No. 61/354,422, entitled “Extension to the Extractor data structure of SVC/MVC file formats,” and filed on Jun. 14, 2010. The teachings of the above-identified provisional patent application are expressly incorporated herein by reference.

The present application is related to the following co-pending, commonly owned U.S. patent application Ser. No. ______/______ entitled “Method and Apparatus for Encapsulating Coded Multi-component Video”, filed concurrently herewith (Attorney Docket No. PU100141). The teachings of the non-provisional patent applications identified immediately above are expressly incorporated herein by reference.

### TECHNICAL FIELD

The present invention relates generally to HTTP streaming. More specifically, the invention relates to encapsulating a media entity for coded multi-component video streams such as scalable video coding (SVC) steams and multi-view coding (MVC) streams for HTTP streaming.

### BACKGROUND OF THE INVENTION

For HTTP streaming applications, at the server side, an encoded video is often encapsulated and stored as a file that is compliant with BMFF, such as an MP4 file. Moreover, to realize adaptive HTTP streaming, the file is usually divided into multiple movie fragments and these fragments are further grouped into segments, which are addressable by client URL requests. In practice, different encoded representations of the video content are stored in these segments, so that a client can dynamically choose the desired representation to download and playback during a session.

Encoded layered video, such as an SVC or MVC bitstream, provides natural support for such bitrate adaptation by enabling different operating points, i.e., representations, in terms of temporal/spatial resolutions, quality, views, etc., by decoding different subsets of the bitstream. However, existing ISO Base Media File Format (BMFF) standards, such as the MP4 file format, do not support separate access of each layer or representation, and thus are not applicable to the HTTP streaming application. As shown in FIG. 1, in MP4 file format, the metadata for all the layers or representations for one media file are stored in the moov Movie Box, while the media content data for all the layers or representations are stored in the mdat Movie Box. In HTTP streaming, when the client requests one layer, the whole file has to be sent since all the layers or representations are mixed together and the client does not know where to find the required layer or representation.

As will be seen later, in adaptive HTTP streaming applications, it is desirable to be able to reference media data samples, such as network abstract layer (NAL) units, across movie fragment or component file boundaries. In SVC/MVC context, such a reference may be built by using mechanisms like “Extractor”. Extractor is an internal file data structure defined in the SVC/MVC Amendments to the AVC file format extension of BMFF: Information Technology—coding of audio-visual objects—Part 15: Advanced Video Coding (AVC) file format, Amendment 2: File format support for Scalable Video Coding, 2008 (pages 15-17). Extractor is designed to enable extraction of NAL units from other tracks by reference, without copying. Here track is a timed sequence of related samples in an ISO base media file. For media data, a track corresponds to a sequence of images or sampled audio. The syntax of Extractor is shown below:

```
class aligned(8) Extractor ( ) {
    NALUnitHeader( );
    unsigned int(8) track_ref_index;
    signed int(8) sample_offset;
    unsigned int ((lengthSizeMinusOne + 1) * 8)
        data_offset;
    unsigned int ((lengthSizeMinusOne + 1) * 8)
        data_length;
}
```

The semantics of the Extractor data structure are:

NALUnitHeader: The NAL unit structure as specified in ISO/IEC 14496-10 Annex G for NAL units of type 20:
nal_unit type shall be set to the extractor NAL unit type (type 31).
forbidden_zero_bit, reserved_one_bit, and reserved_three_{—}2 bits shall be set as specified in ISO/IEC 14496-10 Annex G.
Other fields (nal_ref_idc, idr_flag, priority_id, no_inter_layer_pred_flag, dependency_id, quality_id, temporal_id, use_ref_base_pic_flag, discardable_flag, and output_flag) shall be set as specified in B.4 of Information technology—Coding of audio-visual objects—part 15: Advanced Video Coding (AVC) file format, Amendment 2: File format support for Scalable Video Coding, ISO/IEC 14496-15:2004/Amd. 2:2008 (page 17).

track_ref_index specifies the index of the track reference of type ‘scal’ to use to find the track from which to extract data. The sample in that track from which data is extracted is temporally aligned or nearest preceding in the media decoding timeline, i.e. using the time-to-sample table only, adjusted by an offset specified by sample_offset with the sample containing the Extractor. The first track reference has the index value 1; the value 0 is reserved.

sample_offset gives the relative index of the sample in the linked track that shall be used as the source of information. Sample 0 (zero) is the sample with the same, or the closest preceding, decoding time compared to the decoding time of the sample containing the extractor; sample 1 (one) is the next sample, sample −1 (minus 1) is the previous sample, and so on.

data_offset: The offset of the first byte within the reference sample to copy. If the extraction starts with the first byte of data in that sample, the offset takes the value 0. The offset shall reference the beginning of a NAL unit length field.

data_length: The number of bytes to copy. If this field takes the value 0, then the entire single referenced NAL unit is copied (i.e. the length to copy is taken from the length field referenced by the data offset, augmented by the additional_bytes field in the case of Aggregators).

Further details can be found in Information technology—Coding of audio-visual objects—part 15: Advanced Video Coding (AVC) file format, Amendment 2: File format support for Scalable Video Coding, ISO/IEC 14496-15:2004/Amd. 2:2008.

Currently extractors are only able to extract, by reference, the NAL units from other tracks, but within the same movie box/fragment. In other words, it is not possible to use extractors to extract NAL units from a different segment or file. This restriction limits the use of extractors in the above use case.

Prior solutions to the problems mentioned above have not adequately been established in the art. It would be desirable to provide the ability to parse and encapsulate layers without sacrificing speed and transport efficiency. Such results have not heretofore been achieved in the art.

### SUMMARY OF THE INVENTION

This invention directs to methods and apparatuses for encapsulating component files from a media entity containing more than one layer and for reading a component file.

According to an aspect of the present invention, there is provided a method for encapsulating and creating component files from a media entity containing more than one layer. The method extracts metadata and media data corresponding to the extracted metadata for each layer from the media entity, and identifies references to additional media data related to the extracted media data for each layer. The references are embedded into the extracted media data for each layer. The extracted media data and metadata are associated to enable the creation, for each layer, of a component file containing the extracted metadata and the extracted media data.

According to another aspect of the present invention, there is provided a file encapsulator. The file encapsulator includes an extractor for extracting metadata and media data corresponding to the extracted metadata for each layer from the media entity; a reference identifier for identifying a reference to additional media data, from the media entity, related to said extracted media data for each layer; and a correlator embedding the references into the extracted media data for each layer and for associating the extracted media data with the extracted metadata to enable creation, for each layer, of a component file.

### BRIEF DESCRIPTION OF THE DRAWINGS

The above features of the present invention will become more apparent by describing in detail exemplary embodiments thereof with reference to the attached drawings in which:

FIG. 1 shows an example MP4 file format.

FIG. 2 shows one embodiment of the current invention to encapsulate a media entity.

FIG. 3 shows the structure of an Encapsulator used to encapsulate or create component files from a media entity which contain multiple layers/representations,

FIG. 4 shows an example of associating additional media data with component files based on dependency relationship.

FIG. 5 shows an example to extract an NAL unit, by reference, from a movie box/fragment that is different from the one that the extractor is within.

FIG. 6 shows the involved encapsulation operations for an SVC/MVC type video bitsteam into multiple movie fragments using the invented new extractor data structure.

FIG. 7 shows the structure of a file reader used to read the component files.

FIG. 8 shows the process of reading an SVC/MVC type video bitstream for a video decoder involving the present invention.

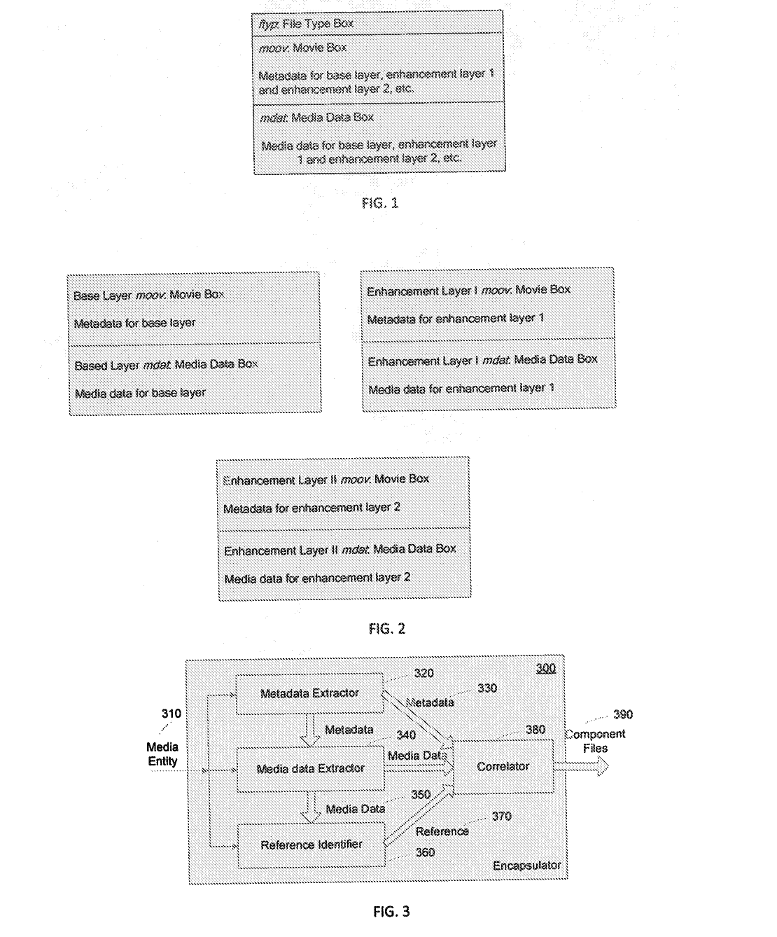

### DETAILED DESCRIPTION

In present invention, a media entity, such as a media file or a set of media files or a streaming media, is divided or encapsulated into multiple movie component files, which are addressable by client URL requests. Here, a component file is used in a broader sense that it represents a fragment, a segment, a file and other equivalent terms thereto.

In one embodiment of the present invention, a media entity containing multiple representations or components is parsed to extract metadata and media data for each representation/component. Examples of the representation/component includes layers, such as layers with various temporal/spatial resolutions and quality in SVC, and views in MVC. In the following, layers are also used to refer to representations/components, and these terms are used interchangeably. The metadata describes, for example, what is contained in the media entity for each representation and how to use the media data contained therein. The media data contain media data samples required for serving the purpose of the media data, e.g. decoding of the content, or any necessary information on how to obtain the required data samples. The extracted metadata and media data for each representation or layer are associated/correlated and stored together for user access. The storing operation can be done physically on a hard drive or other storing media, or can be performed virtually through a relationship management mechanism so that the metadata and media data appear to be stored together when interfacing with other applications or modules when they indeed are actually located in different places on storing media. FIG. 2 illustrates an example of this embodiment. In FIG. 2, a media entity contains three layers: base layer, enhancement layer 1 and enhancement layer 2. The media entity is parsed to extract the metadata and media data for each of the three layers, and those data are stored separately as component files with the metadata and corresponding media data associated together.

FIG. 3 shows the structure of a preferred encapsulator 300 used to encapsulate and create component files from a media entity which contain multiple layers, such as SVC encoded videos. The inputs media entity 310 is passed to a metadata extractor 320 and a media data extractor 340. The metadata extractor 320 extracts the metadata 330 for each layer. The media data extractor 340 takes in the metadata 330 and extracts the corresponding media data 350. Note that in a different embodiment, the metadata extractor 320 and the media data extractor 340 are implemented as one extractor. Both data, metadata 330 and media data 350, are feed into a correlator 380 which associates these two types of data and creates the output component files 390, one component file for each layer.

A layered video, such as a video encoded by AVC extensions of SVC or MVC, contains multiple media components (scalable layers or views). Such an encoded bitstream can provide different operating points, i.e., representations or layers, in terms of temporal/spatial resolutions, quality, views, etc., by decoding different subsets of the bitstream. Furthermore, there exist coding dependencies among the layers of the bitstream, i.e., the decoding of a layer may depend on other layers. Therefore, to request one of such a bitstream's representations may require retrieving and decoding one or more components or media data from the encapsulated video file. To facilitate the extraction process for different representations, an encoded layered video is often encapsulated into an MP4 file in a way that each layer is stored separately in different segments or component files. In this case, it needs to be taken into account that certain media data samples, such as NAL units, of the bitstream are required by, or related to, multiple segments or component files, due to the decoding dependencies described above or other dependencies based on the application.

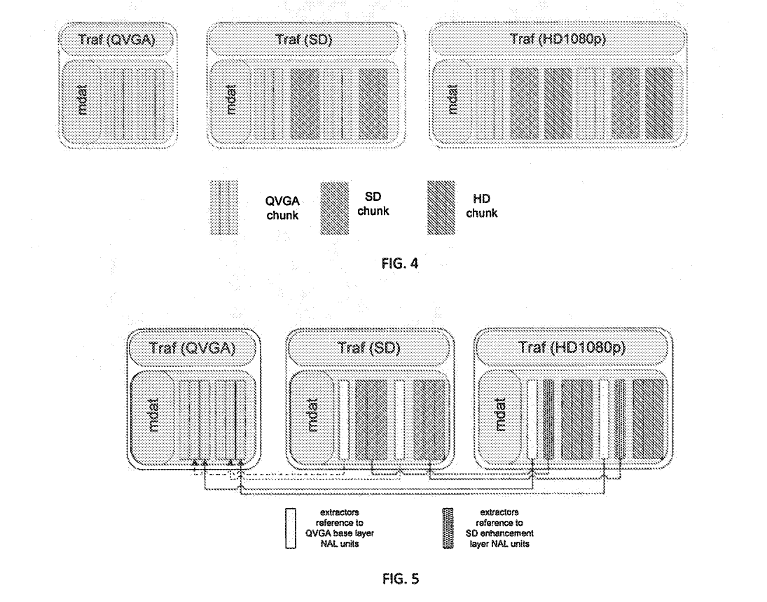

In another embodiment of the present invention, additional media data required by a segment or a component file are extracted and associated with the segment or component file. FIG. 4 shows an example of this embodiment. In the figure, an SVC bitstream has three spatial layers, HD1080p, SD and QVGA. Three movie fragments or component files are formed corresponding to the three operating points, and each is addressable by a different URL. Inside each movie fragment or component file, all the media data samples, NAL units in this example, required for decoding are copied and stored as media samples contained in the “mdat” box. So, when a client requests a particular operating point or representation by using a proper URL, the server can retrieve the corresponding movie fragment or component file and forwarded to the client. In this embodiment, the media data extractor 340 in FIG. 3 further extracts, for each layer, from the input media entity 310 additional media data related to the extracted media data for each of the layers. Correlator 380 further associates the additional extracted media data for each layer to create corresponding component files.

For the sake of storage space saving, it is desirable to be able to reference media data samples, such as NAL units, across movie fragment or component file boundaries, without actually duplicating the same data in each component file. However, ISO Base Media File Format (BMFF) and its extensions currently do not support this feature. To solve this problem, in a further embodiment of the present invention, a reference is identified and built for those additional media data that are related to or required by the media data of a movie fragment or a component file. The reference, rather than those additional media data, is associated with the component file along with the metadata and media data thereof. One can embed the references into the extracted media data for each layer, and then associate the extracted metadata and extracted media data for each layer for creating corresponding component files.

In this embodiment, a Reference Identifier 360 is added to the structure of the Encapsulator 300. The Reference Identifier 360 identifies, from input media entity 310, references 370 to those additional media data that are related to extracted media data 350 for each layer. Then references 370 are associated, via correlator 380, with extracted metadata 330 and extracted media data 350 for each layer, e.g. by embedding said references into said extracted media data, for creating corresponding component files 390.

As discussed earlier, in SVC/MVC context, such a reference may be built by using mechanisms like “Extractor”. Currently extractors are only able to extract, by reference, the NAL units from other tracks, but within the same movie box/fragment. In other words, it is not possible to use extractors to extract NAL units from a different segment or file. This restriction limits the use of extractors in other cases. Hereafter, an extension to the extractor data structure is disclosed, where the extension is aimed to support efficient encapsulation of SVC/MVC type layered video content into multiple component files as described before.

The extension is added to provide the extractor data structure with the extra capability to reference to NAL units that reside in a different movie box/fragment or component file other than the one in which extractor resides.

The extended Extractor is defined as the following:

Syntax:

```
aligned (8) class DataEntryUrlBox (bit (24) flags)
    extends FullBox (’url’, version = 0, flags) {
    string location;
}
aligned (8) class DataEntryUrnBox (bit (24) flags)
    extends FullBox (’urn’, version = 0, flags) {
    string name;
    string location;
}
class aligned (8) Extractor ( ) {
    NALUnitHeader ( );
    DataEntryBox (entry_version, entry_flags) data_entry; // added
extension
    unsigned int(8) track_ref_index;
    signed int(8) sample_offset;
    unsigned int ((lengthSizeMinusOne + 1) * 8)
        data_offset;
    unsigned int ((lengthSizeMinusOne + 1) * 8)
        data_length;
}
```

Semantics:

data_entry is a Uniform Resource Locator (URL) or Uniform Resource Name (URN) entry. Name is a URN, and is required in a URN entry. Location is a URL, and is required in a URL entry and optional in a URN entry, where it gives a location to find the resource with the given name. Each is a null-terminated string using UTF-8 characters. If the self-contained flag is set, the URL form is used and no string is present; the box terminated with the entry-flags field. The URL type should be of a service that delivers a file. Relative URLs are permissible and are relative to the file containing the Movie Box/Fragment that contains the track that the Extractor belongs to.

Other fields have the same semantics as the original Extractor described before.

With the extended extractor, it is now possible to extract a NAL unit, by reference, from a movie box/fragment that is different from the one the extractor is within. FIG. 5 shows such an example, with the same SVC bitstream as FIG. 4 but using the new extended Extractor data structure. As can be seen from the figure, now the SD movie fragment can reference to the NAL units from the QVGA movie fragments Likewise, the HD1080p movie fragment can use the extractors to reference NAL units from both QVGA and SD movie fragments. Compared to FIG. 4, no NAL units are duplicated across these movie fragments, thus storage space is saved.

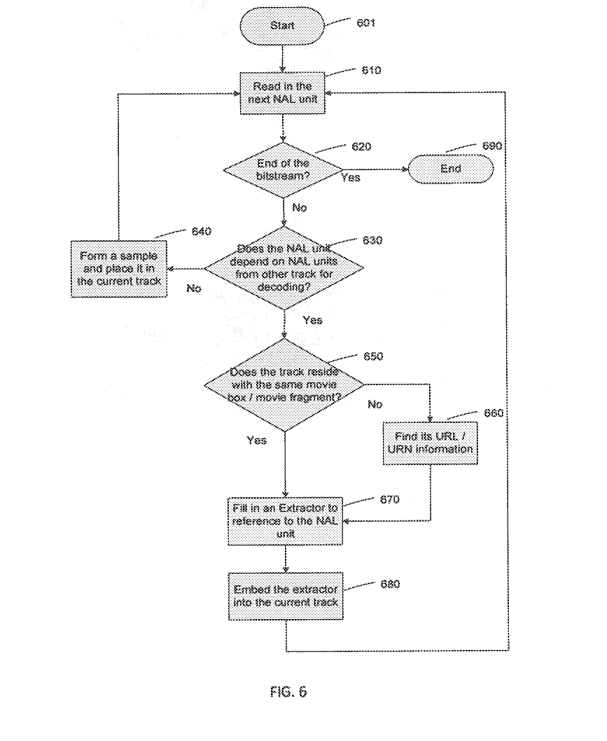

FIG. 6 shows the involved encapsulation operations for an SVC/MVC type video bitsteam into multiple movie fragments or component files using the invented new extractor data structure. The process starts at step 601. Each NAL unit is read in one by one in step 610. If the end of the bitstream is reached in step 620, the process stops at 690; otherwise, the process proceeds to the next step 630. Decision step 630 determines if the current NAL unit depends on NAL units from other track for decoding. If the determination is that the current NAL unit does not depend on NAL units from other tracks for decoding, the control is then transferred to step 640, wherein a sample is formed using the current NAL unit and is placed in the current track. If the determination from step 630 is that there is dependency between the current NAL unit and NAL units from other track, the process goes on to step 650. Decision step 650 further determines if the track from which NAL units are required by the current NAL unit resides within the same movie fragment. If the determination is that the track resides in the same movie fragment, step 670 is employed to fill in an extended Extractor to reference to the NAL unit from that other track. If the determination is that the track resides in a different movie fragment, the URL or URN of such a movie fragment is identified in step 660 and the process proceeds to step 670 with the identified URL and URN to be filled in an extended Extractor. After such an extended Extractor is filled in, it is embedded into the current track in step 680. Then, the process starts over with the next NAL unit in step 610.

To read a component file, a file reader 700 shown in FIG. 7 is employed. A parser 710 first parses the component file to get metadata and media data, and a reference if available. If, according to the decoded reference, the media data are related to media data of other component files such as through decoding dependency, a retriever 720 retrieves the related media data from other component files as indicated in the reference. A processor 730 further processes the metadata and media data obtained from the component file as well as the additional media data if available. The parsing operation by the parser 710 includes various necessary operations to obtain the metadata, the media data that are ready for the processor 730, and the reference ready for the retriever 720. It will include further parsing the metadata and/or the media data when necessary. In one embodiment, the reference is embedded in the media data, and thus the reference is obtained by parsing the media data. If a reference is available, the parsing step further includes analyzing the syntax of the reference and decoding the reference. The processor 730 can contain a video decoder if the component file contains video content. In a different embodiment, the parser and the retriever can be incorporated in the processor.

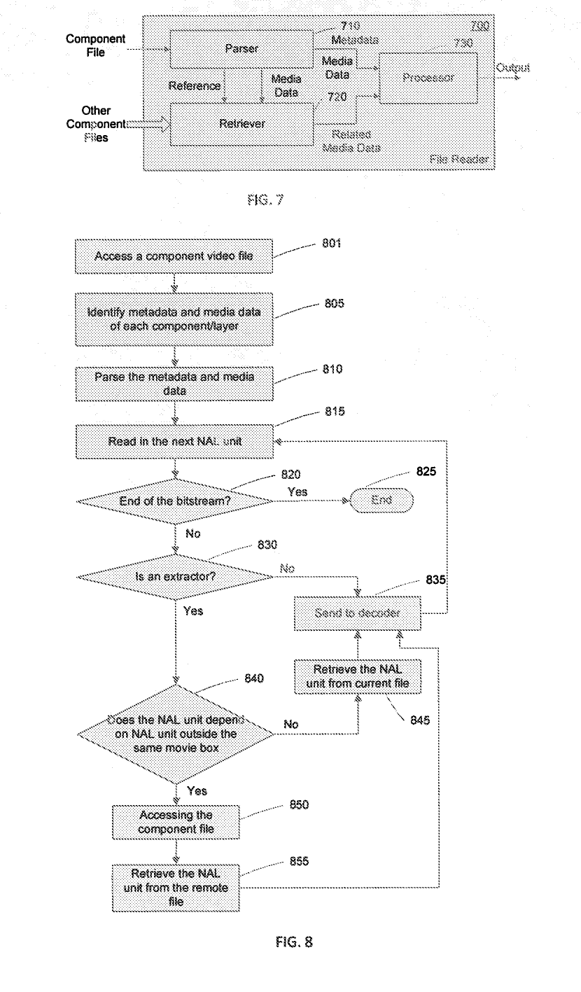

FIG. 8 shows the process of reading an SVC/MVC type video bitstream for a video decoder involving the present invention. Step 801 accesses a component video file whose metadata and media data for each layer are identified in step 805. The identified metadata and media data are parsed in step 810 and each NAL unit of the media data is read in one by one in step 815. For the current NAL unit, a decision is first made at step 820 to determine if the end of the bitstream is reached, and the process ends at step 825 if the answer is “Yes”. Otherwise, the process proceeds to decision step 830 to determine if the current NAL unit is an extractor. If it is not an extractor, which means it is a normal NAL unit containing decoding data, the NAL unit is sent to decoder at step 835. If the current NAL unit is an extractor, it is determined at step 840 that whether the current NAL unit depends on a NAL unit outside the same component file or not. If the required NAL unit is within the same component file, it is retrieved from the current file in step 845 and sent to the decoder at step 835. If the required NAL unit is from another component file, the NAL unit is located using the Data_entry information in the extractor in step 850, retrieved from the remote file in step 855 and then sent to the decoder in step 835.

Although preferred embodiments of the present invention have been described in detail herein, it is to be understood that this invention is not limited to these embodiments, and that other modifications and variations may be effected by one skilled in the art without departing from the scope of the invention as defined by the appended claims.

1. A method for creating component files from a media entity containing more than one layer, the method comprising the steps of:
extracting metadata for each layer from said media entity;
extracting media data from said media entity corresponding to the extracted metadata for each layer of said media entity; and
identifying references to additional media data related to said extracted media data for each layer;
embedding said references into said extracted media data for each layer; and
associating said extracted metadata and extracted media data for each layer for creating corresponding component files.

2. The method of claim 1, wherein said component file is at least one of a movie box, a movie fragment, a segment and a file.

3. The method of claim 2, wherein said media data and additional media data comprise data samples.

4. The method of claim 3, wherein a data sample comprises a network abstract layer unit.

5. The method of claim 4, wherein said additional media data related to said extracted media data for each layer comprise network abstract layer units on which network abstract layer units in said extracted media data depend on.

6. The method of claim 5, wherein said references contain location information of said network abstract layer units in said additional media data.

7. The method of claim 6, wherein said location information comprises at least one of a uniform resource locator and a uniform resource name.

8. The method of claim 7, wherein embedding step further comprises
filling in extractors using said references to said network abstract layer units in said additional media data; and,
embedding said extractors into a track of said extracted media data.

9. A file encapsulator for creating component files from a media entity containing more than one layer, the encapsulator comprising:
an extractor for extracting metadata for each layer from said media entity and for extracting media data from said media entity corresponding to said extracted metadata for each layer of said media entity;
a reference identifier for identifying a reference to additional media data, from said media entity, related to said extracted media data for each layer;
a correlator for embedding said references into said extracted media data for each layer and for associating said extracted media data with said extracted metadata to enable creation, for said each layer, of a component file containing said extracted metadata and said extracted media data.

10. The method of claim 9, wherein said component file is at least one of a movie box, a movie fragment, a segment and a file.

11. The file encapsulator of claim 9, wherein said media data and additional media data comprise data samples.

12. The file encapsulator of claim 11, wherein a data sample comprises a network abstract layer unit.

13. The file encapsulator of claim 12, wherein said additional media data related to said extracted media data for each layer comprise network abstract layer units on which network abstract layer units in said extracted media data depend on.

14. The file encapsulator of claim 13, wherein said references contain location information of said network abstract layer units in said additional media data.

15. The file encapsulator of claim 14, wherein said location information comprises at least one of a uniform resource locator and a uniform resource name.

16. The file encapsulator of claim 15, wherein said correlator further fills in extractors using said references to said network abstract layer units in said additional media data; and, embeds said extractors into a track of said extracted media data.

17. A method for reading a component file, comprising:
parsing said component file to obtain media data and references therein; and
if, according to said references, said media data of said component file are related to media data of other component files, retrieving said related media data from said other component files using said references.

18. The method of claim 17, wherein said media data of said component file are related to media data of other component files according to coding dependency.

19. The method of claim 17, wherein said component file are at least one of a movie box, a movie fragment, a segment and a file.

20. The method of claim 17, wherein said media data and said related media data comprise data samples.

21. The method of claim 20, wherein a data sample comprises a network abstract layer unit.

22. The method of claim 21, wherein said references comprise extractors.

23. A file reader, comprising:
a parser for parsing a component file to obtain media data and a reference therein;
a retriever for retrieving media data related to said media data from other component files according to said reference; and
a processor for processing said metadata, media data and said retrieved media data from other component files.

24. The file reader of claim 23, wherein said media data of said component file are related to media data of other component files according to coding dependency.

25. The file reader of claim 23, wherein said component file are at least one of a movie box, a movie fragment, a segment and a file.

26. The file reader of claim 23, wherein said media data and said related media data comprise data samples.

27. The file reader of claim 26, wherein a data sample comprises a network abstract layer unit.

28. The file reader of claim 27, wherein said references comprise extractors.

29. The file reader of claim 23, wherein said processor comprises a video decoder.
